(19) United States
(12) Patent Application Publication
(10) Pub. No.: US 2025/0371052 A1
(43) Pub. Date: Dec. 4, 2025

(54) METHODS AND SYSTEMS FOR DATA TRANSFORMATION AND ACCESS CONTROL

(71) Applicant: QlikTech International AB, Lund (SE)

(72) Inventors: Henrik Svenell, Malmo (SE); Alexei Pogrebtsov, Ottawa (CA)

(21) Appl. No.: 19/225,734

(22) Filed: Jun. 2, 2025

Related U.S. Application Data
(60) Provisional application No. 63/655,219, filed on Jun. 3, 2024.

(51) Int. Cl. G06F 16/334; G06F 21/62

(52) U.S. Cl. CPC G06F 16/334; G06F 21/6218; G06F 2221/2141

(57) ABSTRACT

The disclosed methods and systems may transform existing datasets into a format that may be consumed by Large Language Models (LLMs). A Retrieval-Augmented Generation application may provide natural language (NL) answers to queries related to the existing data, which may be stored in a knowledge base following transformation. The knowledge base may generate NL responses for users according to their corresponding access rights.

### CROSS-REFERENCE TO RELATED PATENT APPLICATION

This application claims priority to U.S. Prov. App. No. 63/655,219, filed on Jun. 3, 2024, the entirety of which is incorporated by reference herein.

### BACKGROUND

Artificial Intelligence (AI) initiatives often require high-quality, precisely prepared data. This data preparation involves manual cleaning, enhancing, and organizing of data to ensure its accuracy and completeness. Large Language Models (LLMs) are pre-trained on vast amounts of text data, but they require the underlying data to be in a specific form for consumption and analysis. Access control is paramount in maintaining the integrity and confidentiality of the data, as it ensures that sensitive information is accessible only to authorized users. Furthermore, it plays a key role in compliance with data protection regulations by restricting data access to individuals based on their roles and permissions. These and other considerations are discussed herein.

### SUMMARY

It is to be understood that both the following general description and the following detailed description are exemplary and explanatory only and are not restrictive. The present disclosure relates to systems and methods for transforming datasets into a format that may be consumed by Large Language Models (LLMs).

The system may use Retrieval-Augmented Generation (RAG) to generate accurate and relevant responses to natural language queries associated with those datasets. The system may convert unstructured data within the datasets into LLM-consumable data. This may be achieved by splitting the data into manageable chunks, converting each chunk into an embedding via an LLM, and storing the embeddings in a vector database, which may facilitate creation of an associated knowledge base.

An assistant application may then provide natural language answers to queries related to the knowledge base according to corresponding access rights of users. The systems and methods described herein may ensure that users receive responses based on the portions of the underlying data associated with the knowledge base that they may access, while ensuring they do not receive responses based on other portions of the underlying data that are inaccessible to them.

This summary is not intended to identify critical or essential features of the disclosure, but merely to summarize certain features and variations thereof. Other details and features will be described in the sections that follow.

### BRIEF DESCRIPTION OF FIGURES

The accompanying drawings, which are incorporated in and constitute a part of this specification, together with the description, serve to explain the principles of the present methods and systems:

FIG. 1 shows an example system;

FIG. 2 shows an example system;

FIG. 3A shows a first version of an example system;

FIG. 3B shows a second version of an example system;

FIG. 3C shows a third version of an example system;

FIG. 3D shows an example user profile;

FIG. 4 shows an example system;

FIG. 5 shows a flowchart for an example method; and

FIG. 6 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The following detailed description provides an overview of systems and methods that may be used to transform existing datasets into a format that may be consumed by Large Language Models (LLMs). These systems and methods may utilize Retrieval-Augmented Generation (RAG) to generate accurate and relevant responses to natural language queries. The transformation of existing data into LLM-consumable data may involve splitting the data into manageable chunks, converting each chunk into an embedding via an LLM, and storing the embeddings in a vector database. The vector database may therefore function as a “knowledge base” that the RAG application may use to provide natural language answers to queries related to the existing data.

In addition to transforming existing data, the systems and methods described herein may also be used to create a knowledge base from an “app” (application) in an analytics system. This process may involve extracting and structuring a comprehensive set of data and metadata from the app, cleaning and preprocessing the data, converting textual data to embeddings using Natural Language Processing (NLP) models, indexing the embeddings, and building the knowledge base with indexed embeddings and metadata. The RAG system may then convert user queries to embeddings, retrieve relevant data using vector search, and generate responses.

Furthermore, the systems and methods described herein may be used to implement access controls for knowledge bases. This approach may enable natural language assistants to generate natural language responses for users according to their corresponding access rights. This ensures that users receive responses based on the pieces of the knowledge bases they may access, while preventing them from receiving responses based on other pieces of the knowledge base that are inaccessible to them.

The systems and methods described herein may be used in various industries and sectors where large volumes of unstructured data are used, such as healthcare, legal services, education, and business. The ability to transform existing datasets into a format that may be consumed by LLMs, generate accurate and relevant responses to natural language queries, and implement access controls for knowledge bases may provide numerous benefits in these and other fields.

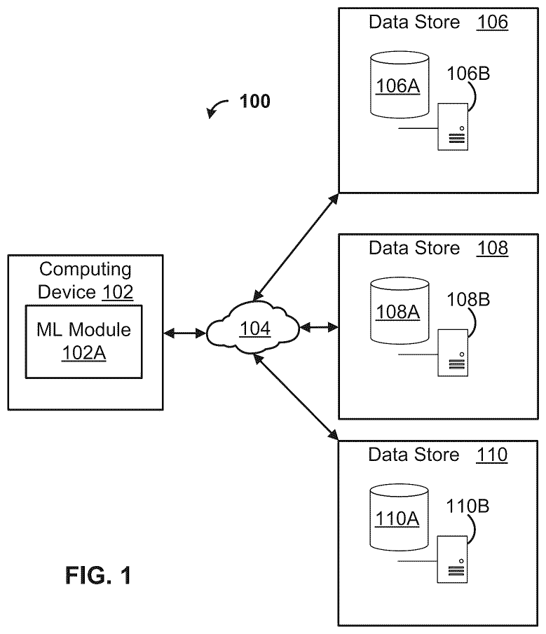

Turning now to FIG. 1, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1 as being resident at the computing device 102, it is to be understood that the ML module 102A may be resident at one or more computing devices that may be local or remote to the computing device 102. Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some aspects, the ML module 102A may access and process data from the databases 106A, 108A, 110A. For example, and as further described herein, the ML module 102A may retrieve data from one or more of the databases 106A, 108A, 110A, process the data to generate embeddings, and store the embeddings in a suitable storage medium. The embeddings may be used to represent the data in a format that is suitable for processing by the ML module 102A or other components of the system 100. In some cases, the ML module 102A may process the data in real-time or near real-time, allowing the system 100 to provide up-to-date responses to user queries or other requests. In other cases, the ML module 102A may process the data in batches, allowing the system 100 to efficiently process large amounts of data. In some aspects, as further described herein, the system 100 may update the embeddings based on changes or updates to the data in the databases 106A, 108A, 110A. For example, when new data is added to a database, or when existing data in a database is updated or changed, the ML module 102A may generate new embeddings or update existing embeddings to reflect the changes or updates to the data. This may allow the system 100 to maintain an up-to-date representation of the data in the databases 106A, 108A, 110A.

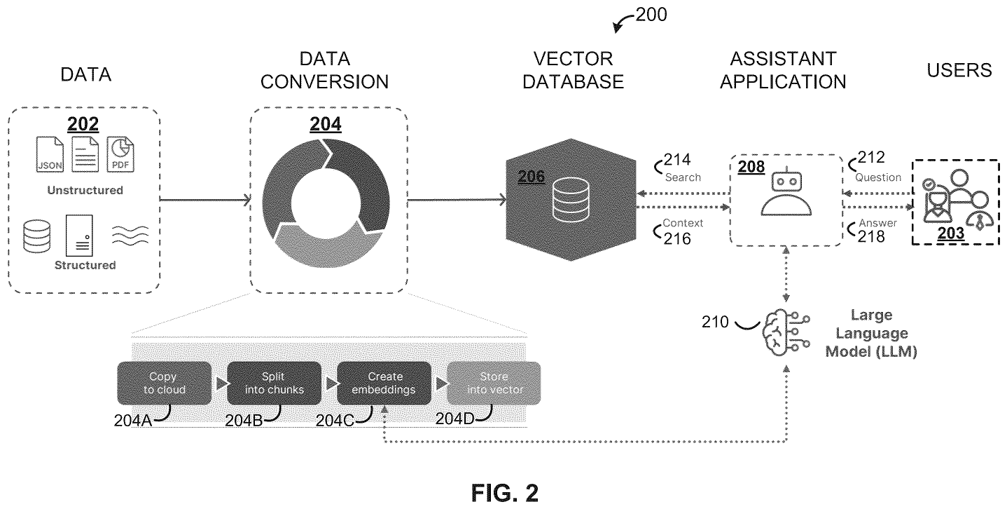

FIG. 2 shows an example system 200. The system 200 may comprise one or more components of the system 100, as further described herein. That is, the capabilities of the system 200 as described herein also apply to the system 100, as the two systems may share—or may each comprise—each described component, resource, device, etc., that performs each of the actions described herein (and potentially not shown).

In some aspects, the system 200 may be utilized to transform data 202 into a format that may be consumed by Large Language Models (LLMs). For example, the data 202 may comprise unstructured, file-based sources, such as presentations, mail archives, text documents, PDFs, transcripts, etc. As shown in FIG. 2, the data 202 may comprise a data warehouse 202A. In some examples, all of the data 202 may be stored in the data warehouse 202A, while in other examples the data warehouse 202A may only store a portion(s) of the data 202. The text of the data 202 may be split into manageable chunks in a data conversion process 204. At step 204A, the data 202 may be copied to a cloud-based environment and split into chunks (e.g., portions of text data) at step 204B. The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 204C. This conversion may be performed by an LLM or another type of machine learning model. Different types of LLMs may be used depending on the specific requirements of the task. In some cases, other machine learning models that are not LLMs may be used to convert the chunks into embeddings. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 204C, each chunk may be converted into an embedding via an LLM, such as the LLM 210 in FIG. 2. Each embedding may comprise a numerical representation of the corresponding chunk of the data 202 that may be consumed/used by an LLM(s) (e.g., by the LLM 210). The embeddings may then be stored in a vector database 206 at step 204D. The vector database 206 may then semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 206 may employ techniques such as dimensionality reduction to optimize the storage and retrieval of embeddings without losing the semantic relationships within the data.

After embeddings are generated and semantically indexed in the vector database 206, an assistant application 208, such as a natural language (“NL”) assistant and/or a chatbot, may provide NL answers to queries related to the data 202. For example, the assistant application 208 may interact with the LLM 210 to process natural language queries from one or more users. The one or more users 203 may interact with the assistant application 208 via a client device, such as the computing device 102, a mobile device, or a web browser. The assistant application 208 may be designed to provide responses in various formats. In some cases, the assistant application 208 may provide text-based responses. In other cases, the assistant application 208 may provide visual or auditory responses. For example, the assistant application 208 may generate a graphical representation of the response, or it may generate an audio file that verbally communicates the response.

As shown in FIG. 2, the one or more users 203 may send a question 212 (e.g., a NL query) to the assistant application 208. The assistant application 208 may perform a search 212 against the vector database 206 in order to receive context 216 that may be based on the embeddings of the data 202, and the context 216 may be used by the assistant application 208 to provide an answer 218 (e.g., a NL answer/output). In this way, the “knowledge” used by the system 200 to provide answers 218 to searches 212 may be augmented using the data 202, which forms the basis for the context 216 provided to the assistant application 208.

The assistant application 208 may be designed to interact with users in a conversational manner. This may allow for more complex and dynamic interactions between the users 203 and the assistant application 208. For example, the assistant application 208 may be capable of maintaining a conversation with a user over multiple exchanges, keeping track of the context of the conversation and providing responses that are relevant to the ongoing conversation. In some aspects, the assistant application 208 may be integrated with other systems or applications to provide additional functionality. For example, the assistant application 208 may be integrated with a customer relationship management system, a content management system, a data analysis system, or any other type of system or application. This integration may allow the assistant application 208 to access additional data, leverage additional computational resources, or provide additional services to users.

In analytics systems (e.g., SaaS systems), the unstructured, file-based sources that may be used to generate a knowledge base(s), such as the vector database 206, may be contained within one or more “apps” (short for applications). From a technical standpoint, an app in an analytics system is a self-contained environment designed to facilitate data analysis and visualization. It serves as a comprehensive workspace where users can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create a knowledge base from an app, such as for use in a Retrieval-Augmented Generation (RAG) system (e.g., the system 200), the system 200 may retrieve and structure a comprehensive set of data and metadata from the app. This data forms the foundation of the knowledge base, allowing the RAG system to generate accurate and contextually relevant responses to user queries. First, the system 200 gathers details about the data connections, including information about the data sources connected to the app (e.g., the data 202) and the necessary authentication credentials. Understanding the structure of the data model is crucial, so that the system 200 may extract information on the tables and fields imported into the app, the associations between tables, and relevant metadata for each field.

The data load script, which may define how data is imported and transformed, may be captured by the system 200, along with any applied data transformations. Information about the sheets and visualizations within the app, including their layout, types, underlying data, and metadata, may also collected by the system 200. This includes reusable dimensions, measures, and master visualizations defined in the app. The system 200 may also collect the content of any stories or presentations built within the app, including the visualizations and text used, as well as titles, descriptions, and relevant metadata. Additionally, details of saved bookmarks, including selections and filters, may be retrieved by the system 200. If the app uses any custom visualizations or extensions, the system 200 may gather information about these custom objects and their metadata.

To ensure the knowledge base remains current and accurate, the system 200 may periodically capture static data extracts or snapshots of the data used in the app. For example, a purpose-built API(s) may be used by the system 200 to programmatically extract the necessary data and metadata, ensuring that all relevant transformations and calculations are captured. The extracted data may then be organized into a structured format suitable for the knowledge base by the system 200. Including all relevant metadata provides context and enhances the usability of the knowledge base.

Indexing the knowledge base supports efficient retrieval of information, and techniques such as vectorization and semantic search, as performed by the vector database 206, enhance the retrieval capabilities for the system 200. Finally, setting up processes to periodically update the knowledge base with new data and changes from the app ensures the knowledge base remains current and accurate. By extracting and structuring this comprehensive set of information from an app, the system 200 may create—and maintain—a robust knowledge base for a RAG system, enabling it to provide accurate and contextually relevant answers to user queries.

To transform data from an app for use in the system 200, several steps are taken to ensure the data is appropriately structured and accessible for generating accurate and contextually relevant responses. First, data from the app is extracted by the system 200. This includes data from various sources connected to the app, as well as the data model, which comprises tables and their relationships. The data load script and any transformations applied within the app may be replicated by the system 200 to maintain consistency.

Once extracted, the data may be cleaned and pre-processed by the system 200. This may involve handling missing values, normalizing data formats, ensuring that all the transformations applied by the system 200 are consistent, a combination thereof, and/or the like. The goal of data cleaning and pre-processing is to create a structured dataset that the system 200 may easily index and query. Embeddings, which are dense vector representations of the data, may be created by the system 200, capturing the semantic meaning of textual content.

Text data associated with an app, such as descriptions, titles, and narratives, may be processed using Natural Language Processing (NLP) techniques by the large language model (LLM) 210. Models like BERT, GPT, or other transformer-based models may be used by the system 200 to convert this text data into embeddings as well (or in the alternative). For structured data, feature vectors representing all numerical attributes and/or categorical attributes within the structured data may be created by the system 200. Techniques like principal component analysis (PCA) and/or use of one or more autoencoders may be used by the system 200 to reduce dimensionality and create embeddings. The embeddings may then be indexed by the vector database 206. This indexing permits efficient similarity searches, enabling the system 200 to quickly retrieve relevant data points based on the query embeddings.

The embedded data forms a knowledge base, which includes indexed embeddings and associated metadata, ensuring that the context and relationships within the data are preserved by the system 200. Such knowledge bases may be stored in the vector database 206, which for purposes of explanation is shown in FIG. 2 as being a single vector database 206 but in some examples may comprise a plurality of vector databases 206. The system 200 may use knowledge bases stored in the vector database(s) 206 (and/or elsewhere) to generate responses as described herein. When a user's 203 question 212 is received, the system 200 may convert the question 212 into an embedding, retrieve relevant data from the vector database 206 using vector search, and/or generate responses using the assistant application 208. The retrieved data forms a context 216 that is then used to provide a contextually accurate and relevant answer(s) 218.

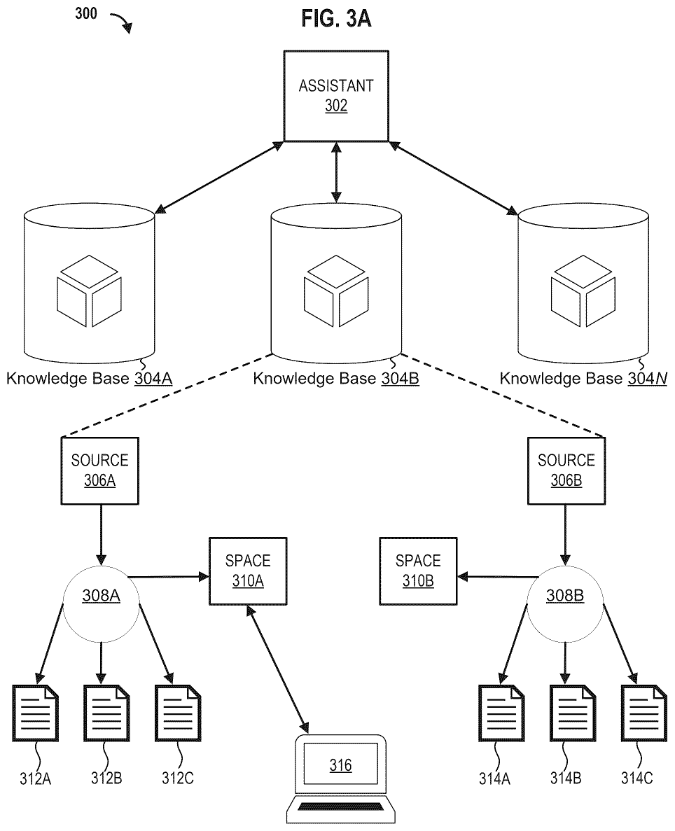

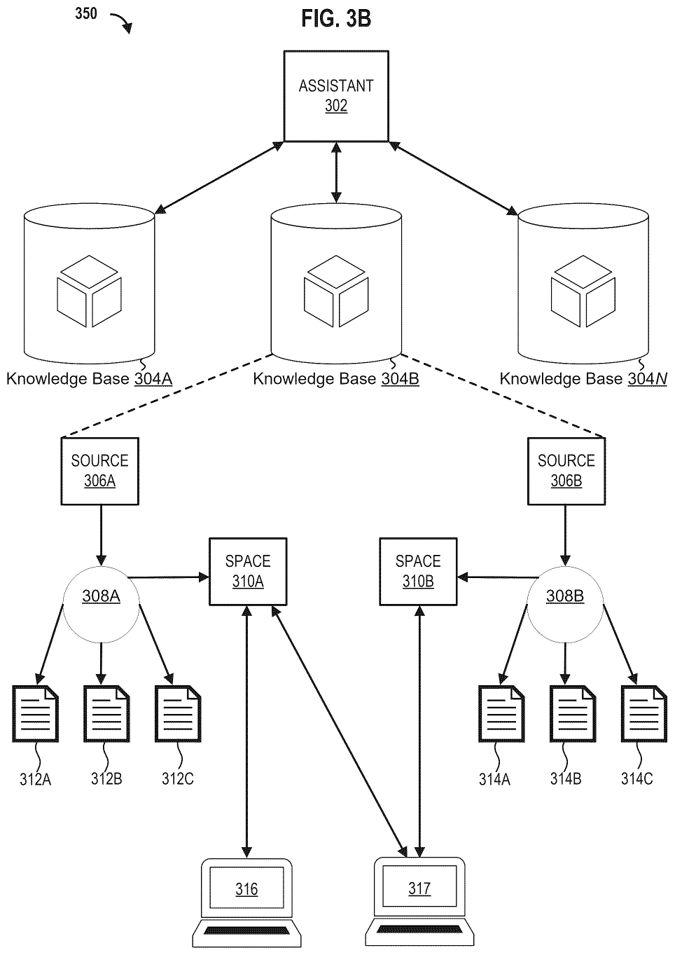

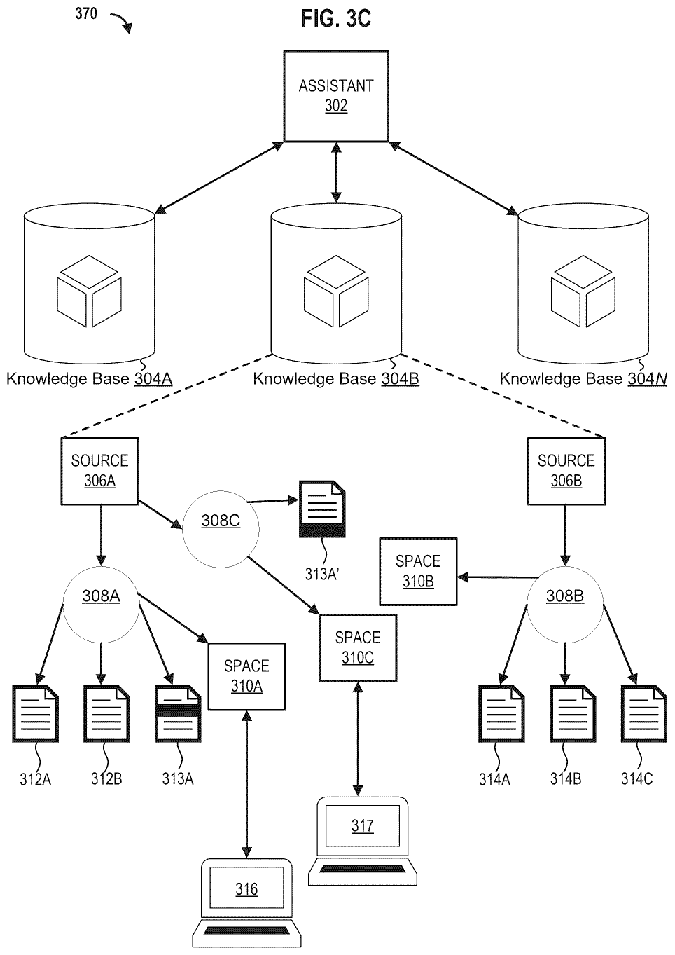

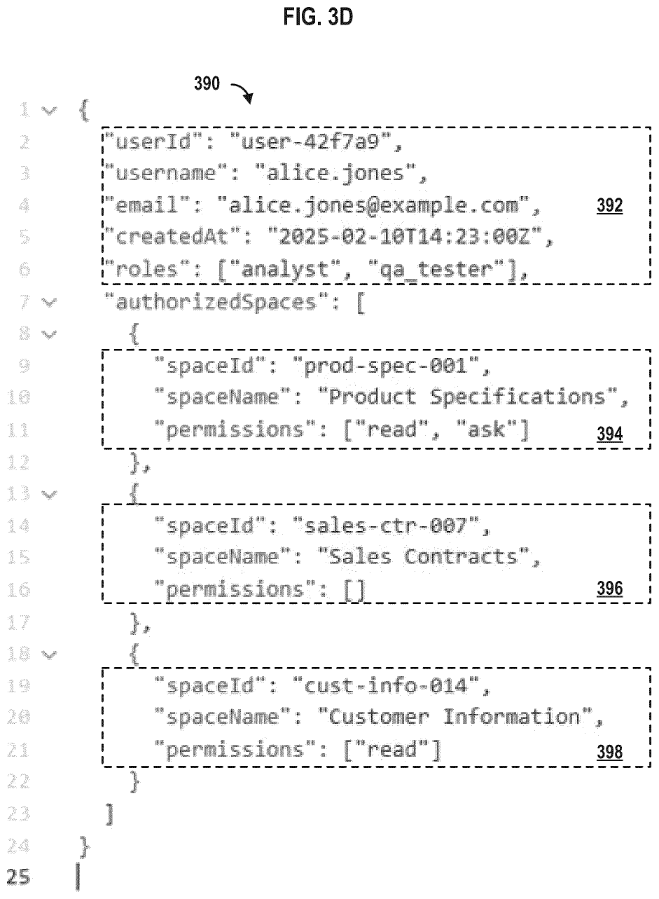

In the system 300 shown in FIG. 3, an assistant 302 may be in communication with a plurality of knowledge bases 304A-304N, and each of the knowledge bases 304A-304N may be associated with one or more sources. For example, the knowledge base 304B shown in FIG. 3 is associated with a first source 306A and a second source 306B. Each source may be associated with a file connection. For example, the first source 306A shown in FIG. 3 is associated with a first file connection 308A. Each file connection may be associated with a space, the combination of which may provide access control to the knowledge base. For example, the first file connection 308A shown in FIG. 3 is associated with a first plurality of files 312A-312C and a first space 310A. A user may submit NL queries to one or more of the knowledge bases 304A-304N via a client device 316 (e.g., the computing device 102). For example, the user may submit a NL query to the assistant 302 via the space 310A, and the assistant 302 may generate a response to the NL query based on the first plurality of files 312A-312C, based on a user profile, credential, etc., that indicates the user may access the first plurality of files 312A-312C via the first connection 308A.

Each NL assistant may be associated with one or more knowledge bases (e.g., one or more vector databases or portions thereof). And each knowledge base may store (or have access to) a collection of one or more sources (or portions/chunks thereof). The one or more sources for each knowledge base may be local or may be remote to the particular knowledge base. And each source, of the one or more sources, may store (or indicate or describe) one or more unstructured documents/data of a plurality of unstructured documents/data (and/or portions/chunks thereof). Access to the plurality of unstructured documents/data within a particular source may be implemented by using file connections. And each file connection may be associated with a space that provides access control to one or more unstructured documents/data of the plurality of unstructured documents/data (and/or portions/chunks thereof).

Each space associated with each source is, or is not, shared with each of the users, and each user may be given different access rights to each space. Access rights for each user may be derived from security rules for the corresponding app(s) that was used to create the corresponding knowledge base(s), as those security rules may define access permissions and data visibility to ensure that users only see the data they are authorized to access. For example, each user may be associated with a user profile (or credential, etc.), and the user profile may be associated with a plurality of spaceIDs for a particular source within a particular knowledge base. And the user profile may indicate that at least one spaceID of the plurality of space IDs is accessible by the user profile, while at least one other spaceID may not be accessible by that user profile.

It should be noted that a spaceID may be associated with a particular portion of an unstructured document/data as well, which allows for multiple layers of access control within a single unstructured document/data. A spaceID may function as a unique identifier for a logical container with built-in security parameters. Each space may be uniquely identified by a spaceID, which may be implemented as a globally unique identifier (GUID). The spaceID may be retrieved via specific functions or API calls when content resides in a shared or managed space. The system 300 may utilize spaceIDs to scope retrieval operations and enforce security measures. The isolation of content may be achieved by scoping retrieval to the spaceID. The NL assistant 302 may only search vector indexes for documents explicitly added to knowledge bases within spaces that the user has permission to access. This approach may prevent information leakage between different business units or projects that utilize separate spaces.

A user profile may include various parameters that determine access rights to different components of the system 300. The user profile may contain information about which spaces, identified by spaceIDs, the user is authorized to access. The user profile may include role-based permissions that define what actions the user may perform within each accessible space. These permissions may include the ability to view assistants, create assistants, manage assistants, view knowledge bases, create knowledge bases, manage knowledge bases, index knowledge bases, or search knowledge bases. The user profile may also specify whether the user has permission to review conversations and view feedback in assistants. This permission may be granted through an audit admin user role, for example. The user profile may further indicate whether the user has permission to chat with assistants, create new assistants, move assistants between spaces, open assistants, delete assistants, edit assistants, view assistant knowledge bases, add/or remove knowledge bases, or review answers and feedback.

The user profile may contain space role permissions that control access to individual spaces. These space role permissions may include owner permissions, management permissions, editing permissions, viewing permissions, or consumption permissions. The specific combination of space role permissions may determine what actions the user may perform within each space. For example, a user with “Can view” and “Can consume data” permissions in a shared space may be able to chat with an assistant in that space. The user profile may also specify different levels of access for different types of spaces. The user may have different permissions for shared spaces versus managed spaces. In a shared space, the user profile may indicate whether the user has “Owner,” “Can manage,” “Can edit data in apps,” “Can edit,” “Can view,” or “Can consume data” permissions. In a managed space, the user profile may indicate whether the user has “Owner,” “Can manage,” “Can publish,” “Can contribute,” “Can view,” “Has restrictive view,” “Can consume data,” or “Can operate” permissions.

The user profile may also include entitlement information that affects available permissions. Different entitlements, such as Professional, Full User, or Analyzer entitlements, may grant access to different sets of permissions. A user with a Professional or Full User entitlement may have access to a broader range of permissions than a user with an Analyzer entitlement. The user profile may further specify whether the user has tenant administrator, analytics administrator, or data administrator privileges. These administrator privileges may grant additional permissions for managing data connections, assistants, or knowledge bases across multiple spaces. Tenant administrators may be able to manage all data connections in managed, shared, and personal spaces. Analytics administrators may be able to manage data connections in managed and shared spaces but not in other users' personal spaces. Data administrators may be able to manage data connections in data spaces but not in other users' personal spaces.

The user profile may contain information about which specific documents within accessible spaces the user may access. This access control may be implemented at the document level through file connections, such as the first file connection 308A or the second file connection 308B. Each file connection may be associated with a specific space, such as the first space 310A or the second space 310B. The user profile may indicate which file connections the user may access. This information may determine which documents, such as the first plurality of files 312A-312C or the second plurality of files 314A-314C, the user may access. The user profile may also specify whether the user has permission to create, move, open, delete, or edit knowledge bases associated with these file connections. The user profile may further indicate whether the user has permission to index sources, set up index schedules, get answers from knowledge bases using an assistant, or view sources from knowledge bases.

The user profile may include information about which specific chunks or portions of documents the user may access. This granular access control may be implemented through spaceIDs associated with particular portions of unstructured documents. The user profile may indicate which spaceIDs, corresponding to specific document chunks, the user may access. This approach may allow for multiple layers of access control within a single unstructured document. Different users may have access to different portions of the same document based on their respective user profiles. The system 300 may enforce these access controls when retrieving document chunks in response to user queries. The NL assistant 302 may only retrieve chunks from documents or portions of documents that the user is authorized to access based on their user profile.

The user profile may also contain information about which knowledge bases the user may access. Each knowledge base, such as the first knowledge base 304A, the second knowledge base 304B, or the Nth knowledge base 304N, may be associated with one or more sources. Each source, such as the first source 306A or the second source 306B, may be associated with one or more file connections. The user profile may indicate which knowledge bases, sources, and file connections the user may access. This information may determine which data the NL assistant 302 may use to generate responses to the user's queries. The user profile may also specify whether the user has permission to create, move, open, delete, or edit knowledge bases. The user profile may further indicate whether the user has permission to index sources, set up index schedules, get answers from knowledge bases using an assistant, or view sources from knowledge bases.

The system 300 may implement additional access control mechanisms beyond user profiles. The system 300 may use a role-based access control model that assigns permissions based on user roles. Different roles may have different sets of permissions. The system 300 may also implement discretionary access control, where the owner of a resource may determine who may access that resource. The system 300 may further implement mandatory access control, where access decisions are made by a central authority based on security policies. The system 300 may use a combination of these access control models to provide comprehensive security for knowledge bases and their associated data.

The system 300 may also implement access control through authentication mechanisms. Users may be required to authenticate themselves before accessing the system. Authentication may be performed through various methods, such as username and password, multi-factor authentication, or single sign-on. The system 300 may verify the user's identity and retrieve their user profile during the authentication process. The user profile may then be used to determine what resources the user may access. The system 300 may also implement session management to maintain the user's authenticated state during their interaction with the system. Each session may be associated with a specific user profile and its corresponding access rights.

The system 300 may implement audit logging to track user actions and access attempts. Each access to a knowledge base, source, or file may be logged along with the user's identity and the time of access. These audit logs may be used for security monitoring, compliance verification, or forensic analysis. The system 300 may also implement intrusion detection to identify and respond to unauthorized access attempts. Suspicious activities, such as multiple failed authentication attempts or access attempts to unauthorized resources, may trigger alerts or automated responses. The system 300 may further implement data encryption to protect sensitive data. Data may be encrypted both in transit and at rest to prevent unauthorized access.

In this way, when a user (e.g., via a client device, such as the client device 316 or the computing device 102) sends a NL query to an NL assistant, the response that is generated would only be based on the access rights associated with that user's user profile. This is because the user profile would indicate which spaceID(s) is accessible by that user (e.g., which portion(s) of the plurality of unstructured documents/data are accessible based on the access rights for that user profile).

As illustrated in FIG. 3B, the system 350 may implement an access control regime that enables multiple client devices to access different spaces within the system. The system 350 may differ from the system 300 shown in FIG. 3A by incorporating a second client device 317. The second client device 317 may be associated with a different user profile than the client device 316. Each user profile may contain distinct access permissions that determine which spaces and files the corresponding user may access. The client device 316 may have access rights to the first space 310A and its associated files 312A, 312B, and 312C. The second client device 317 may have access rights to the second space 310B and its associated files 314A, 314B, and 314C. In some implementations, the client device 316 may also have access to the second space 310B, while the second client device 317 may not have access to the first space 310A.

The NL assistant 302 in system 350 may process queries from both client devices. The NL assistant 302 may determine the access rights of each user by examining their respective user profiles. When the client device 316 submits a query, the NL assistant 302 may retrieve information from the first knowledge base 304A, the second knowledge base 304B, or the Nth knowledge base 304N, but only from spaces and files that the user of client device 316 has permission to access. Similarly, when the second client device 317 submits a query, the NL assistant 302 may retrieve information only from spaces and files that the user of the second client device 317 has permission to access. This access control mechanism may ensure that users receive responses based only on the information they are authorized to access, thereby maintaining data security and confidentiality.

The system 350 may implement a space-based access control regime. Each space may function as a logical container with built-in security parameters. The first space 310A and the second space 310B may each be uniquely identified by a spaceID. The spaceID may be implemented as a globally unique identifier (GUID). The system 350 may utilize these spaceIDs to scope retrieval operations and enforce security measures. The isolation of content may be achieved by scoping retrieval to the spaceID. The NL assistant 302 may only search vector indexes for documents explicitly added to knowledge bases within spaces that the user has permission to access. This approach may prevent information leakage between different business units or projects that utilize separate spaces.

As illustrated in FIG. 3C, the access control system 370 may implement a more granular access control regime than the systems 300 and 350. The access control system 370 may differ from the system 300 by incorporating a third file connection 308C and a third space 310C. The third file connection 308C may branch from the first source 306A and may connect to the third space 310C. The access control system 370 may also differ from the system 300 by implementing document-level access controls. The system 370 may include files 313A and 313A′, which may contain the same data but may have different portions accessible depending on the space through which they are accessed.

The file 313A may be accessible through the first space 310A, while the file 313A′ may be accessible through the third space 310C. A portion of the file 313A may be inaccessible when accessed through the first space 310A. A different portion of the file 313A′ may be inaccessible when accessed through the third space 310C. This configuration may allow for multiple layers of access control within a single unstructured document. Different users may have access to different portions of the same document based on their respective user profiles and the spaces they can access.

The access control system 370 may enable more sophisticated access control scenarios than the systems 300 and 350. For example, a user with access to both the first space 310A and the third space 310C may be able to access different portions of the same document through different spaces. The NL assistant 302 may generate responses based on the combined accessible portions of the document. Alternatively, a user with access to only one of these spaces may receive responses based only on the portions of the document accessible through that space. This granular access control may be particularly useful in scenarios where different parts of a document contain information with different sensitivity levels or are relevant to different business units or projects.

The access control system 370 may also implement a combination of space-based and document-level access controls. The system may assign spaceIDs not only to spaces but also to specific portions of documents. A user profile may indicate which spaceIDs, corresponding to specific document chunks, the user may access. The NL assistant 302 may enforce these access controls when retrieving document chunks in response to user queries. The NL assistant 302 may only retrieve chunks from documents or portions of documents that the user is authorized to access based on their user profile. This approach may provide a high level of flexibility and security in managing access to sensitive information.

Additionally, the response that is generated may also be based on prior NL queries (and/or their corresponding responses) that the user may have previously sent to the NL assistant. This feature enables the NL assistant to maintain context and continuity in its interactions with users. By considering previous queries and responses, the assistant can provide more personalized and relevant answers. For example, if a user has previously asked about a specific topic, the assistant can use that information to tailor its responses to subsequent related queries. This contextual awareness allows the assistant to build upon previous conversations, clarify ambiguities, and provide more comprehensive information over time. Additionally, this feature can help the assistant recognize patterns in a user's inquiries, anticipate follow-up questions, and offer more proactive assistance. The system may store these prior interactions securely, ensuring that the contextual information is only used for the specific user and in accordance with their access rights. This approach not only enhances the user experience by providing more coherent and informed responses but also improves the efficiency of the information retrieval process by leveraging the user's interaction history.

There are several benefits of this novel approach for knowledge base composition with access controls. For example, information derived via unstructured documents/data may be organized across a plurality of knowledge bases that each define high-level groupings of the information according to a specific topic or a business area, such as Product descriptions, Sales contracts, Customer information, etc. As another example, because each knowledge base is a collection of unstructured documents/data that may be stored remotely and disparately, there is no need to transfer the unstructured documents/data into a single location, as access may be controlled via the file connections. A further benefit is that assigning file connections to spaces and sharing the spaces with specific groups of users allows for granular access control. Furthermore, reassigning a file connection from one space to another allows for easily changing access rights for different groups of users.

The systems and methods described herein implement access control mechanisms to ensure that users can access knowledge bases according to their corresponding access rights. However, there could be variations in these mechanisms. For instance, different types of access control models could be used, such as discretionary access control, mandatory access control, or role-based access control. The method used to assign access rights to users could also be varied. Additionally, the system could be designed to handle more complex access control scenarios, such as situations where access rights change dynamically or where multiple users have overlapping access rights.

The present system and methods may be implemented in various industries and sectors where large volumes of unstructured data are used. For instance, in the healthcare sector, the system can be used to transform patient records, clinical trial data, and medical literature into a format that can be consumed by Large Language Models (LLMs). This could enable healthcare professionals to quickly retrieve relevant information and make informed decisions, thereby improving patient care and outcomes. In the field of legal services, the system can be used to convert legal documents, case law, and statutes into LLM-consumable data. This could allow legal professionals to generate accurate and relevant responses to legal queries, thereby enhancing the efficiency of legal research and case preparation.

In the education sector, the system can be used to transform textbooks, research papers, and lecture notes into a format that can be consumed by LLMs. This could enable educators and students to generate accurate and relevant responses to educational queries, thereby enhancing the learning experience and academic performance. In the business sector, the system can be used to convert business reports, market research data, and industry trends into LLM-consumable data. This could enable business professionals to generate accurate and relevant responses to business queries, thereby enhancing strategic decision-making and business performance.

Furthermore, the system's ability to implement access controls for knowledge bases can be particularly useful in environments where data privacy and security are paramount. For instance, in the financial services industry, the system can ensure that users receive responses based on the pieces of the knowledge bases they are authorized to access, thereby preventing unauthorized access to sensitive financial data.

In an example use case of the system 300, consider a scenario within a multinational corporation that handles sensitive financial documents, product designs, and customer information. The corporation may utilize the system 300 to manage access to these documents. The system may assist employees in retrieving information through natural language queries. The NL assistant 302 may serve as the interface for employees to interact with the system. An employee may submit a natural language query regarding a specific financial report through their client device 316. The NL assistant 302 may process this query according to the employee's user profile 390, as shown in FIG. 3D.

The NL assistant 302 may be associated with multiple knowledge bases, such as 304A, 304B, and 304N. Each knowledge base may contain different categories of corporate documents. The knowledge base 304B, for instance, may be associated with two sources. The first source 306A may contain financial reports. The second source 306B may contain product design documents. Each source may be connected to the system via file connections. The first file connection 308A may provide access to the first source 306A. These file connections may function as pathways through which the NL assistant 302 accesses the documents.

The first file connection 308A may be associated with a first space 310A. This space may be a virtual container that holds a specific subset of documents, such as the first plurality of files 312A-312C. These files could be quarterly financial reports that the employee is authorized to access. The space 310A may be configured with access controls. These controls may determine which users or groups of users are allowed to retrieve documents from it. The employee's user profile 390 may contain profile attributes 392 including userID, username, email, creation date, and assigned roles. The user profile 390 may also include first space attributes 394, second space attributes 396, and third space attributes 398. Each set of space attributes may contain a spaceID, spaceName, and associated permissions for different spaces in the system. For example, the first space attributes 394 may define access parameters for a “Product Specifications” space. The second space attributes 396 may define access parameters for a “Sales Contracts” space. The third space attributes 398 may define access parameters for a “Customer Information” space. When the employee submits their query, the NL assistant 302 may check the employee's user profile 390 to determine their access rights. The user profile 390 may include information about which spaces, identified by spaceIDs, the employee is authorized to access. The permissions field within each space attributes section may indicate what actions the user can perform within that particular space. If the employee's profile indicates that they have access to the first space 310A, the NL assistant 302 may retrieve the relevant documents from the first plurality of files 312A-312C to generate a response to the query. The response generated by the NL assistant 302 may be based on the content of the accessible documents. The response may optionally also be based on any prior interactions the employee has had with the system. This approach may ensure that the information provided is both relevant and permissible for the employee to access. The system may maintain the integrity and confidentiality of the corporation's documents by ensuring that sensitive information is not disclosed to unauthorized personnel.

In another example use case, a multinational corporation may implement the system 350 to manage access to sensitive documents across different departments. The system 350 may enable multiple employees to simultaneously access different spaces within the system according to their respective roles. The NL assistant 302 may serve as the central interface for all employees. A finance department employee may use the client device 316 to submit queries about quarterly financial projections. A product development manager may use the second client device 317 to inquire about new product specifications.

The NL assistant 302 may process queries from both employees concurrently. The system 350 may determine the access rights of each employee by examining their respective user profiles. The finance employee may have a user profile 390 similar to that shown in FIG. 3D. This user profile 390 may contain profile attributes 392 including userID, username, email, creation date, and assigned roles. The profile attributes 392 may identify the employee as a member of the finance department with specific access permissions. The finance employee's profile may include first space attributes 394 granting access to the first space 310A and its associated financial documents 312A, 312B, and 312C. The product development manager may have a different user profile. The product development manager's profile may include second space attributes 396 providing access to the second space 310B and its product specification files 314A, 314B, and 314C. The product development manager's profile may also contain first space attributes 394 granting limited access to certain financial information in the first space 310A due to their role in budget planning. The finance employee's profile may not include second space attributes 396. This absence may prevent access to the product specifications in the second space 310B.

When the product development manager submits a query about product development costs, the NL assistant 302 may retrieve information from the second knowledge base 304B. The system may access financial documents from the first space 310A and relevant product specifications from the second space 310B. The response may incorporate data from both spaces. The system may reference the product development manager's user profile 390 to verify access permissions for each space. The permissions field within the first space attributes 394 and second space attributes 396 may determine what specific information can be retrieved. When the finance employee submits a query about financial projections, the NL assistant 302 may only retrieve information from the first space 310A. The system may check the finance employee's user profile 390 and may find only first space attributes 394 with appropriate permissions. The system may not include any product specification data from the second space 310B in the response. The absence of second space attributes 396 in the finance employee's profile may prevent access to this information. This multi-user access control mechanism may ensure that each employee receives information tailored to their authorization level. The system 350 may maintain data security by preventing unauthorized access across departmental boundaries. The spaceIDs contained in the space attributes sections of each user profile 390 may serve as unique identifiers for the logical containers with built-in security parameters.

In a third example use case, a multinational corporation may implement the access control system 370 to manage document access with granular, content-level restrictions. The system 370 may enable access control not just at the document level but also within specific portions of individual documents. The corporation may use this capability to manage sensitive merger and acquisition (M&A) documents. The NL assistant 302 may provide responses based on precisely defined accessible content within documents. A senior executive may use the client device 316 to query information about an upcoming acquisition. A department manager may use the second client device 317 to request information about how the acquisition affects their department.

The access control system 370 may implement document-level access controls through the third file connection 308C and the third space 310C. The M&A document may exist as file 313A when accessed through the first space 310A and as file 313A′ when accessed through the third space 310C. The senior executive may have a user profile similar to the user profile 390 shown in FIG. 3D. This user profile 390 may contain profile attributes 392 including userID, username, email, creation date, and assigned roles. The profile attributes 392 may identify the senior executive as a member of the executive leadership team with elevated access permissions. The senior executive's profile may include first space attributes 394 granting access to the first space 310A. The department manager may have a different user profile. The department manager's profile may include third space attributes 398 providing access to the third space 310C. The financial details and strategic implications within the M&A document may be inaccessible to the department manager. The operational changes affecting specific departments may be visible to both the senior executive and the department manager.

When the senior executive submits a query about the acquisition's financial impact, the NL assistant 302 may retrieve comprehensive information from file 313A through the first space 310A. The response may include financial projections, strategic considerations, and departmental impacts. The system may reference the senior executive's user profile 390 to verify access permissions for the first space 310A. The permissions field within the first space attributes 394 may determine what specific information can be retrieved. The first space attributes 394 may indicate that the senior executive has “Owner” or “Can manage” permissions for the “Product Specifications” space. These elevated permissions may allow access to all portions of the M&A document. When the department manager submits a similar query, the NL assistant 302 may only retrieve the portions of the document available in file 313A′ through the third space 310C. The response may include only the operational changes affecting their department. The system may exclude all financial details and strategic implications. The department manager's user profile may contain third space attributes 398 with more limited permissions such as “Can view” or “Has restrictive view” for the “Customer Information” space. These restricted permissions may limit access to only specific portions of the M&A document. This content-level access control may provide significant advantages over the systems 300 and 350. The corporation may maintain a single source document while precisely controlling which portions are accessible to different users. The system 370 may enable more sophisticated information sharing. Sensitive details may remain protected while relevant information may be made available to those who need it.

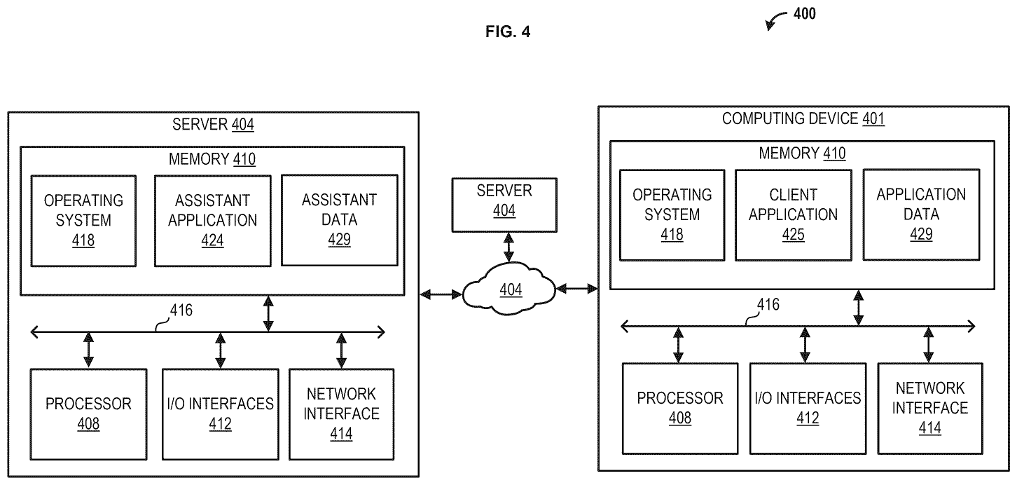

The present methods and systems may be computer-implemented. FIG. 4 shows a block diagram depicting a system/environment 400 comprising non-limiting examples of a computing device 401 and a server 402 connected through a network 404. Either of the computing device 401 or the server 402 may be a computing device, such as any of the devices of the system 100 shown in FIG. 1. In an aspect, some or all steps of any described method may be performed on a computing device as described herein. The computing device 401 may comprise one or multiple computers configured to store application data 429, and/or the like. The server 402 may comprise one or multiple computers configured to store assistant data 429. Multiple servers 402 may communicate with the computing device 401 via the through the network 404.

The computing device 401 and the server 402 may be a digital computer that, in terms of hardware architecture, generally includes a processor 408, system memory 410, input/output (I/O) interfaces 412, and network interfaces 414. These components (408, 410, 412, and 414) are communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 may execute software stored within the system memory 410, to communicate data to and from the system memory 410, and to generally control operations of the computing device 401 and the server 402 pursuant to the software.

The I/O interfaces 412 may be used to receive user input from, and/or for providing system output to, one or more devices or components. User input may be provided via, for example, a keyboard and/or a mouse. System output may be provided via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the server 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise the application data 429, the client application 425, and a suitable operating system (O/S) 418. In the example of FIG. 4, the software in the system memory 410 of the server 402 may comprise the assistant data 429, the assistant application 424, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are shown herein as discrete blocks, although it is recognized that such programs and components may reside at various times in different storage components of the computing device 401 and/or the server 402. An implementation of the system/environment 400 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

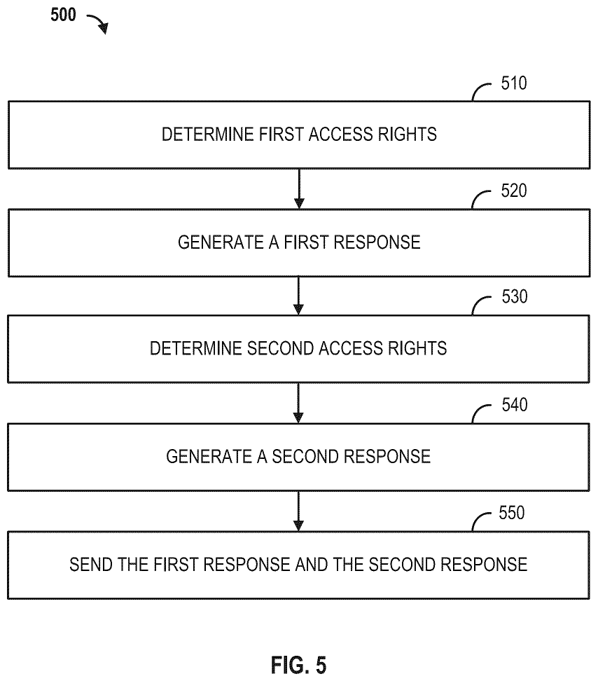

FIG. 5 shows a flowchart of an example method 500. The method 500 may be performed in whole or in part by a single computing device, a plurality of computing devices, and the like. For example, one or more of the steps of the method 500 may be performed by the assistant application 208 and/or the assistant 302 (e.g., resident at, or controlled by, the server 106B, 108B, or 110B), a component(s) thereof, and/or one or more devices in communication therewith.

At step 510, the method 500 may involve determining first access rights based on a first natural language query associated with a first client device. The determination may be based on a first user profile associated with the first client device. The first access rights may indicate the first client device may access a first space. For example, as illustrated in FIG. 3B, the client device 316 may submit a natural language query to the NL assistant 302. The NL assistant 302 may then determine, based on a user profile associated with the client device 316, that the client device 316 has access rights to the first space 310A. The user profile may contain information about which spaces, identified by spaceIDs, the user is authorized to access. The system may access a database of user permissions based on the first user profile. The system may retrieve space identifiers associated with the user profile from the database. These space identifiers may comprise globally unique identifiers (GUIDs) associated with logical containers having built-in security parameters.

At step 520, the method 500 may involve generating a first response based on the first access rights. The first response may use information from a first plurality of files accessible via the first space. For example, as shown in FIG. 3B, the NL assistant 302 may generate a response using information from the files 312A, 312B, and 312C accessible via the first space 310A. The generation of the first response may involve determining relevant information from the first plurality of files based on the first natural language query. The system may cause a large language model to process the relevant information. The system may then generate the first response based on output from the large language model. The NL assistant 302 may retrieve information from the first knowledge base 304A, the second knowledge base 304B, or the Nth knowledge base 304N, but only from spaces and files that the user of client device 316 has permission to access.

At step 530, the method 500 may involve determining second access rights based on a second natural language query associated with a second client device. The determination may be based on a second user profile associated with the second client device. The second access rights may indicate the second client device may access the first space and a second space. The first user profile may not indicate access rights to the second space. For example, as illustrated in FIG. 3B, the second client device 317 may submit a natural language query to the NL assistant 302. The NL assistant 302 may then determine, based on a second user profile associated with the second client device 317, that the second client device 317 has access rights to both the first space 310A and the second space 310B. The system may cause the first client device to be restricted from accessing the second space based on the first user profile. The system may access a database of user permissions based on the second user profile. The system may retrieve space identifiers associated with the second user profile from the database.

At step 540, the method 500 may involve generating a second response based on the second access rights. The second response may use information from the first plurality of files accessible via the first space and a second plurality of files accessible via the second space. For example, as shown in FIG. 3B, the NL assistant 302 may generate a response using information from both the files 312A, 312B, and 312C accessible via the first space 310A and the files 314A, 314B, and 314C accessible via the second space 310B. The NL assistant 302 may retrieve information from the first knowledge base 304A, the second knowledge base 304B, or the Nth knowledge base 304N, but only from spaces and files that the user of the second client device 317 has permission to access.

At step 550, the method 500 may involve sending the first response to the first client device and the second response to the second client device. The sending may be based on the first natural language query and the second natural language query. For example, as illustrated in FIG. 3B, the NL assistant 302 may send the first response to the client device 316 and the second response to the second client device 317. The system may generate a log of accessed information based on the first response and the second response. The system may determine usage patterns for the first space and the second space based on the log. The system may cause an update to access rights for at least one of the first user profile or the second user profile based on the usage patterns. The system may also receive a third natural language query from the first client device requesting information related to the second space. The system may determine, based on the first user profile, that the first client device lacks access rights to the second space. The system may send a notification to the first client device indicating that the requested information is not accessible based on the lack of access rights.

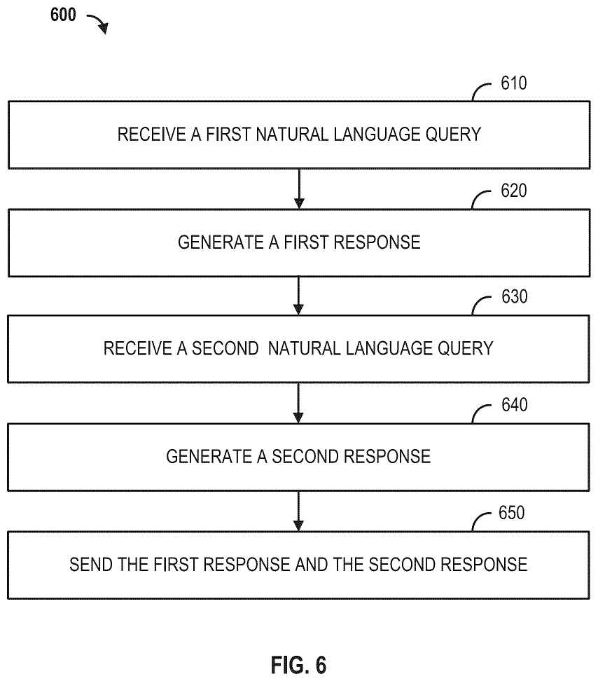

FIG. 6 shows a flowchart of an example method 600. The method 600 may be performed in whole or in part by a single computing device, a plurality of computing devices, and the like. For example, one or more of the steps of the method 600 may be performed by the assistant application 208 and/or the assistant 302 (e.g., resident at, or controlled by, the server 106B, 108B, or 110B), a component(s) thereof, and/or one or more devices in communication therewith.

At step 610, the method 600 may involve receiving a first natural language query via a first client device. The first client device may be associated with a first user profile. The first user profile may indicate first access rights to a first space. The first space may comprise a first file. The first access rights may indicate the first client device may access a first plurality of portions of the first file. For example, as illustrated in FIG. 3C, the client device 316 may submit a natural language query to the NL assistant 302. The client device 316 may be associated with a user profile similar to the user profile 390 shown in FIG. 3D. The user profile may contain profile attributes 392 and first space attributes 394. The first space attributes 394 may grant access to the first space 310A. The first space 310A may contain the file 313A. The first access rights may indicate the client device 316 may access certain portions of the file 313A. Some portions of the file 313A may be inaccessible when accessed through the first space 310A. This may be represented by the black bar over a portion of the file icon 313A in FIG. 3C.

At step 620, the method 600 may involve generating a first response based on the first access rights. The first response may be based on the first plurality of portions of the first file. For example, as shown in FIG. 3C, the NL assistant 302 may generate a response using information from the accessible portions of the file 313A via the first space 310A. The generation of the first response may involve determining relevant information from the accessible portions of the file 313A based on the first natural language query. The system may cause a large language model to process the relevant information. The system may then generate the first response based on output from the large language model. The NL assistant 302 may retrieve information from the first knowledge base 304A, the second knowledge base 304B, or the Nth knowledge base 304N, but only from spaces and files that the user of client device 316 has permission to access. The first natural language query and a second natural language query may be substantially similar. The first response may differ from a second response due to different access rights. The system may access a database of user permissions based on the first user profile. The system may retrieve space identifiers associated with the first user profile from the database. These space identifiers may comprise globally unique identifiers (GUIDs) associated with logical containers having built-in security parameters.

At step 630, the method 600 may involve receiving a second natural language query via a second client device. The second client device may be associated with a second user profile. The second user profile may indicate second access rights to a second space. The second space may comprise the first file. The second access rights may indicate the second client device may access a second plurality of portions of the first file. For example, as illustrated in FIG. 3C, the second client device 317 may submit a natural language query to the NL assistant 302. The second client device 317 may be associated with a different user profile than the client device 316. The second user profile may contain profile attributes and third space attributes 398. The third space attributes 398 may grant access to the third space 310C. The third space 310C may provide access to the file 313A′. The file 313A′ may contain the same data as file 313A. The second access rights may indicate the second client device 317 may access certain portions of the file 313A′. Some portions of the file 313A′ may be inaccessible when accessed through the third space 310C. This may be represented by the black bar over a portion of the file icon 313A′ in FIG. 3C. The second space and the first space may be associated with the same source. In FIG. 3C, both the first space 310A and the third space 310C may be associated with the first source 306A. The first plurality of portions and the second plurality of portions may at least partially overlap. This may mean that some portions of the file 313A accessible via the first space 310A may also be accessible as portions of the file 313A′ via the third space 310C.

At step 640, the method 600 may involve generating a second response based on the second access rights. The second response may be based on the second plurality of portions of the first file. For example, as shown in FIG. 3C, the NL assistant 302 may generate a response using information from the accessible portions of the file 313A′ via the third space 310C. The generation of the second response may involve determining relevant information from the accessible portions of the file 313A′ based on the second natural language query. The system may cause a large language model to process the relevant information. The system may then generate the second response based on output from the large language model. The NL assistant 302 may retrieve information from the first knowledge base 304A, the second knowledge base 304B, or the Nth knowledge base 304N, but only from spaces and files that the user of the second client device 317 has permission to access. The system may access a database of user permissions based on the second user profile. The system may retrieve space identifiers associated with the second user profile from the database. These space identifiers may comprise globally unique identifiers (GUIDs) associated with logical containers having built-in security parameters.

At step 650, the method 600 may involve sending the first response to the first client device and the second response to the second client device. The sending may be based on the first natural language query and the second natural language query. For example, as illustrated in FIG. 3C, the NL assistant 302 may send the first response to the client device 316 and the second response to the second client device 317. The system may generate a log of accessed information based on the first response and the second response. The system may determine usage patterns for the first space and the second space based on the log. The system may cause an update to access rights for at least one of the first user profile or the second user profile based on the usage patterns. The system may also receive a third natural language query from the first client device requesting information related to the third space 310C. The system may determine, based on the first user profile, that the first client device lacks access rights to the third space 310C. The system may send a notification to the first client device indicating that the requested information is not accessible based on the lack of access rights. This granular access control may be particularly useful in scenarios where different parts of a document contain information with different sensitivity levels or are relevant to different business units or projects.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
based on a first natural language query associated with a first client device, determining, based on a first user profile associated with the first client device, first access rights, wherein the first access rights indicate the first client device may access a first space;
generating, based on the first access rights, a first response using information from a first plurality of files accessible via the first space;
based on a second natural language query associated with a second client device, determining, based on a second user profile associated with the second client device, second access rights, wherein the second access rights indicate the second client device may access the first space and a second space, wherein the first user profile does not indicate access rights to the second space;
generating, based on the second access rights, a second response using information from the first plurality of files accessible via the first space and a second plurality of files accessible via the second space; and
sending, based on the first natural language query and the second natural language query, the first response to the first client device and the second response to the second client device.

2. The method of claim 1, further comprising causing, based on the first user profile, the first client device to be restricted from accessing the second space.

3. The method of claim 1, wherein generating the first response comprises:
determining, based on the first natural language query, relevant information from the first plurality of files;
causing a large language model to process the relevant information; and
generating, based on output from the large language model, the first response.

4. The method of claim 2, further comprising:
receiving, based on a third natural language query from the first client device, a third request for information related to the second space;
determining, based on the first user profile, that the first client device lacks access rights to the second space; and
sending, based on the lack of access rights, a notification to the first client device indicating that the requested information is not accessible.

5. The method of claim 1, wherein determining the first access rights and the second access rights comprises:
accessing, based on the first user profile and the second user profile, a database of user permissions; and
retrieving, based on the database, space identifiers associated with each user profile.

6. The method of claim 5, wherein the space identifiers comprise globally unique identifiers (GUIDs) associated with logical containers having built-in security parameters.

7. The method of claim 1, further comprising:
generating, based on the first response and the second response, a log of accessed information;
determining, based on the log, usage patterns for the first space and the second space; and
causing, based on the usage patterns, an update to access rights for at least one of the first user profile or the second user profile.

8. A method comprising:
receiving, via a first client device, a first natural language query, wherein the first client device is associated with a first user profile indicating first access rights to a first space comprising a first file, wherein the first access rights indicate the first client device may access a first plurality of portions of the first file;
based on the first access rights, generating, based on the first plurality of portions of the first file, a first response;
receiving, via a second client device, a second natural language query, wherein the second client device is associated with a second user profile indicating second access rights to a second space comprising the first file, wherein the second access rights indicate the second client device may access a second plurality of portions of the first file;
based on the second access rights, generating, based on the second plurality of portions of the first file, a second response; and
sending, based on the first natural language query and the second natural language query, the first response to the first client device and the second response to the second client device.

9. The method of claim 8, wherein the first natural language query and the second natural language query are substantially similar, and wherein the first response differs from the second response.

10. The method of claim 8, wherein the second space and the first space are associated with at least one of: a same source or a same file connection.

11. The method of claim 8, wherein the first plurality of portions and the second plurality of portions at least partially overlap.

12. The method of claim 8, wherein determining the first access rights and the second access rights comprises:
accessing, based on the first user profile and the second user profile, a database of user permissions; and
retrieving, based on the database, space identifiers associated with each user profile.

13. The method of claim 12, wherein the space identifiers comprise globally unique identifiers (GUIDs) associated with logical containers having built-in security parameters.

14. The method of claim 8, further comprising:
generating, based on the first response and the second response, a log of accessed information;
determining, based on the log, usage patterns for the first space and the second space; and
causing, based on the usage patterns, an update to access rights for at least one of the first user profile or the second user profile.

15. A system comprising:
a first client device;
a second client device; and
an assistant application configured to at least:
generate, based on first access rights associated with the first client device, a first response to a first natural language query;
generate, based on second access rights associated with the second client device, a second response to a second natural language query, wherein the first natural language query and the second natural language query are associated with a file; and
send the first response to the first client device and the second response to the second client device, wherein the first response and the second response are based on the file, and wherein the first response differs from the second response based on the first access rights and the second access rights.

16. The system of claim 15, wherein the first natural language query and the second natural language query are substantially similar.\

17. The system of claim 15, wherein the first access rights and the second access rights are associated with at least one of: a same source or a same file connection.

18. The system of claim 15, wherein portions of the file accessible via the first access rights and portions of the file accessible via the second access rights at least partially overlap.

19. The system of claim 15, wherein the assistant application is further configured to:
access, based on a first user profile associated with the first client device and a second user profile associated with the second client device, a database of user permissions; and
retrieve, based on the database, space identifiers associated with each user profile.

20. The system of claim 15, wherein the assistant application is further configured to:
generate, based on the first response and the second response, a log of accessed information;
determine, based on the log, usage patterns for spaces associated with the first access rights and the second access rights; and
cause, based on the usage patterns, an update to access rights for at least one of a first user profile associated with the first client device or a second user profile associated with the second client device.
